(19) United States
(12) Patent Application Publication
(10) Pub. No.: US 2018/0022620 A1
(43) Pub. Date: Jan. 25, 2018

(54) Water Filtration Device

(71) Applicant: Achal Garg, Cincinnati, OH (US)

(72) Inventor: Achal Garg, Cincinnati, OH (US)

(21) Appl. No.: 15/218,066

(22) Filed: Jul. 24, 2016

(51) Int. Cl. C02F 1/00; B01D 35/26; B01D 39/20; C02F 1/28; B01D 29/88

(52) U.S. Cl. CPC C02F 1/002; C02F 1/283; B01D 29/88; B01D 39/2068; B01D 35/26; C02F 2307/04; B01D 2201/303; B01D 2201/304

(57) ABSTRACT

Disclosed herein is a portable, single-chambered, hand-pressurized water filtration device employing a two-part filtration unit consisting of a ceramic filter and an activated charcoal filter through which pressurized water is forced, filtered and removed via a spigot in fluid communication with the filtration unit.

### FIELD OF THE INVENTION

The invention described herein relates to a method and means for filtering untreated water of questionable potability by employing a device having two internal filters and a hand-pump for urging the untreated water through the filters and out an externally attached spigot which is in fluid communication with the internal filters.

### BACKGROUND OF THE INVENTION

There are two types of water purification devices: those with (a) gravity filter and those with (b) external pressure filters. Almost all gravity filters have two compartments: one for the unclean water to be filtered and a second to receive clean, filtered water. The two chambers are connected (or separated) by a filter. Because the gravity filter uses gravity to move the water from the unclean compartment to the clean compartment, it effects the transfer of water slowly across the filter, and the filtration rate is especially time consuming if the filter pore size is small (0.2 to 0.3 microns).

The external pressure filter devices use a pressurized water line connection or a pump powered by electricity. The pressure-type filter devices are efficient and fast but are unsuitable when there is no running water connection or electric power source. Additionally, the external pressure filter devices are expensive and beyond the means of poor people.

The water filtration device described herein is inexpensive, portable and easy to maintain. The disclosed device has no moving parts except the hand pump. It is relatively fast and efficient, especially when compared to the gravity-type filters. It provides clean, safe drinking water anywhere and from any source of water, e.g., well, pond, river or cistern.

### DESCRIPTION OF THE PRIOR ART

The prior art is replete with examples of purification and filtration devices for the treatment of water. Relevant to the invention claimed herein are the following: Pub. No. US 2006/0157398, which was published on Jul. 20, 2006, describes a water filtration system for the removal of bacteria and protozoa as well as certain chemical contaminants. The disclosed system comprises a container having first and second filters disposed in the interior of the container. The first filter is a carbon composite filter and the second filter is composed of sub-micron hollow fiber membrane and includes a filtered water outlet.

Pub. No. US 2009/0039037, which was published on Feb. 12, 2009, describes a portable water disinfecting and purification apparatus comprising a first chamber into which water may be drawn by negative pressure and a second chamber into which the water from the first chamber can be forced by positive pressure and passed across a micro-filter positioned within the second chamber through which water can be forced by said positive pressure to an outlet for purified water.

U.S. Pat. No. 8,926,840, which issued to Hull et al. on Jan. 6, 2015, describes a personal portable drinking container having a filter assembly and squeezable sides. Squeezing the sides pressurizes the water in the container, directs it through the filter assembly, and allows it to exit through an uncapped top opening into a mouth for drinking.

U.S. Pat. No. 8,349,172 which issued to Schoeb on Jan. 8, 2013, describes a filter and pump unit for filtering out particles from a fluid, said unit comprising a filter housing having an inlet and an outlet for the fluid to be filtered, a filter element, and an impeller, as part of a rotary pump, for pumping the fluid from the inlet, through the filter element and out the outlet.

### SUMMARY OF THE INVENTION

Notwithstanding the similarities and acknowledged usefulness of the filtration devices described by the disclosures of the prior art, there remains a need for an inexpensive, portable water filtration device that can process relatively large quantities of water quickly and effectively. The elements of the filtration device disclosed herein are readily available and easily replaced when worn out. Specifically, the water filtration device described and claimed herein comprises an air-tight container having inner and outer surfaces, a top side, a bottom side and a continuously curving lateral side extending between the top and bottom sides. Preferably, the top side is a removable lid threadably attached to the upper contiguous perimeter of the continuously curving lateral sides. Within the removable lid is a lidded opening serving as a port for the introduction of water to be filtered by the device. The port is fitted with a strainer for the removal of any debris in the water.

A spigot is threadably attached to the outer surface of the lateral side of the device. A two-part filtration unit consisting of a ceramic filter and a charcoal filter is positioned on the inner surface, preferably diametrically opposite the spigot, and threadably attached to and in fluid communication with the spigot.

And, to force or urge the untreated water through the two-part filtration unit and out the spigot, a hand-activated pump is attached to the removable lid to pressurize water within the device thus forcing it through the filtration unit and into the spigot by which the filtered water can be removed from the device.

### BRIEF DESCRIPTION OF THE DRAWING

FIG. 1 is a schematic perspective view of the water filtration device in partial cross-section.

FIG. 2 is an enlarged, isolated, partial cross-sectional view of the filtration unit and spigot. And,

FIG. 3 is an enlarged, isolated, cross-sectional view of an alternative embodiment of the filtration unit.

### DESCRIPTION OF THE PREFERRED EMBODIMENTS

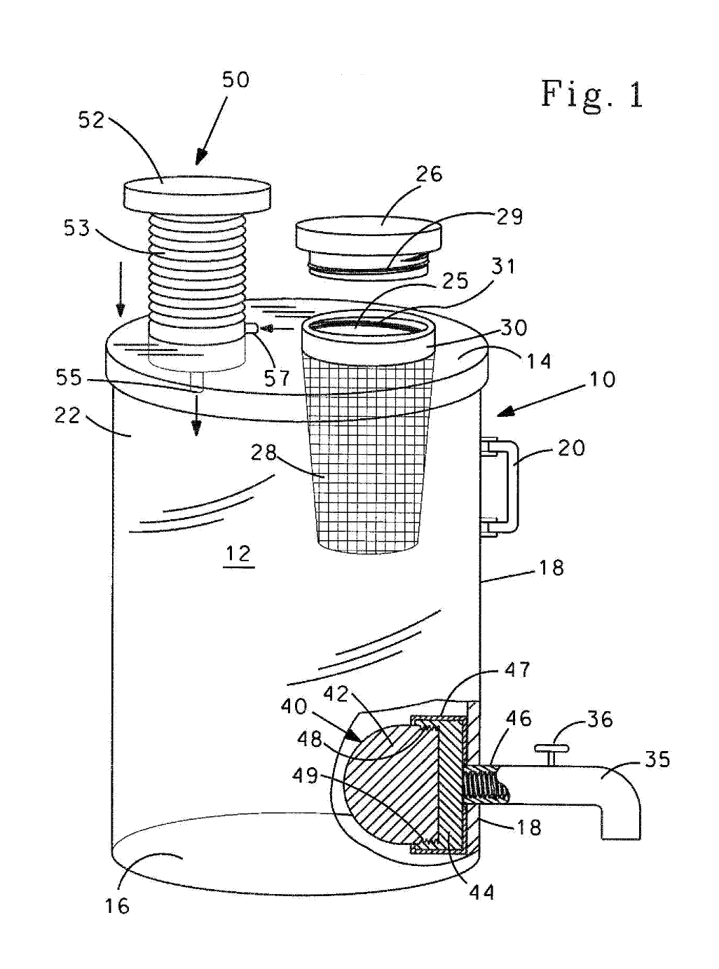

FIG. 1, a schematic representation of the water filtration device 10 described and claimed herein, depicts all elements of the water filtration device. The air-tight container 12 is conventional in that it has a top side 14, which is a removable lid permitting easy access to the interior of the container. Access to the interior is important to enable cleaning the container from time to time and servicing the two-part filtration unit 40. Servicing the filtration unit will involve simply removing the lid 14 for cleaning and/or replacing the filters. The lid is removably attached to the container 12 in any of several ways. Typically, there is either a friction fit or threadable attachment between the lid 14 and the upper, outer perimeter 22 of the lateral side 18 of the container. In whichever manner the lid 14 is attached to the container 12, an air-tight fit is essential for the effective use of the filtration device 10.

The lateral side 18 of the container is continuously curving giving the container 12 a rounded shape. The container has, of course, a bottom side 16 diametrically opposed to the top or lid 14 of the container. To facilitate transporting and manipulating the device 10, a carrying means 20, or handle, is conveniently attached to the lateral side 18.

The lid 14 also has a lidded 26 port 25 for the introduction of water for filtration into the device 10. The port 25 is equipped with a fitting 30, typically annular, positioned in the plane of the lid. The fitting is designed to accommodate the lid 26, which can be threaded 29 to mate with a threaded 31 fitting 30, or the lid and fitting can be engaged and secured with a friction fit. The purpose of the port lid 26 is, of course, to ensure the air-tightness of the container 12 to facilitate the effectiveness of the filtration device 10.

The port 25 is also equipped with a strainer 28, typically attached to and suspended from fitting 30 within perimeter of the orifice of the port. The strainer 28 is the first level of filtration for water introduced into the device 10. The strainer 28 has a mesh fine enough to prevent large particle debris from entering the container 12, yet large enough to permit and to enable the filtration device to be filled rapidly to effect efficient filtration of the water. The strainer 28 will need to be accessed for routine cleaning, and that can be accomplished by removing the port lid 26 and disengaging the strainer from its fitting and the port, or by removing the container lid 14.

While the strainer 28 is effective for removing gross material from the water to be filtered by the device 10, meaningful filtration to provide potable water is achieved by a two-part filtration unit 40. The filtration unit 40 is attached to the lower, interior lateral side 18 of the container and comprises two filtration elements: a ceramic filter 42 and an activated carbon filter 44.

Water filtration by the filtration device 10 is effected by forcing or urging strained water in the container through the two-part filtration unit 40 and through a threaded exit fitting 46 to which the filter housing 47 and the spigot 35 are diametrically attached. The water in the container of the device is forced or urged through the two-part filtration unit 40 by means of a hand-activated pump 50 positioned in the removable lid 14.

The hand-pump 50 is conveniently attached to the removable lid 14 of the device. Preferably, it is a simple compression pump having a pair of valves 55 and 57, a pressure plate 52 for the application of force by the palm of the hand on the air in the bellows 53, which, in turn, forces air through valve 55 into the interior of the container 12, thus pressurizing the water in the container directing its exit via the open spigot after being filtered by the two-part filter unit. After the bellows is collapsed and the air expelled, the bellows is biased to return to its expanded state. Valve 55 closes, valve 57 opens, air re-enters the bellows 53 and the hand-pumping action can once again be initiated, and repeated until all or most of the water is filtered through the two-part filtration unit and dispensed through the spigot.

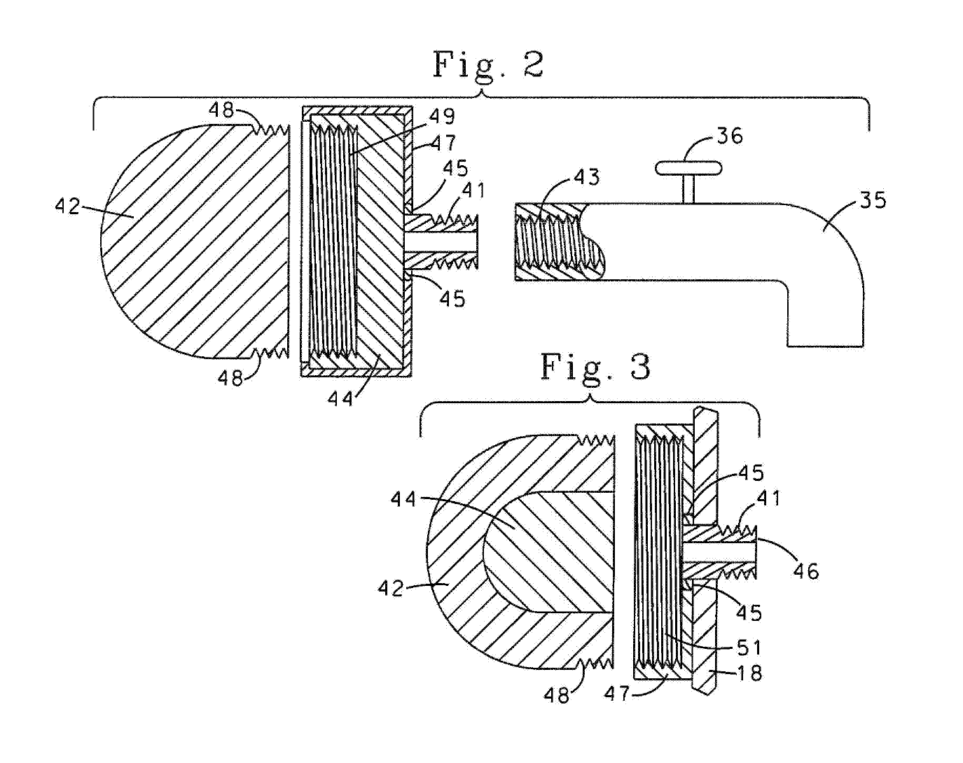

A preferred embodiment of the two-part filtration unit 40 is depicted schematically in FIG. 2. In this embodiment, the ceramic filter 42 and the activated charcoal filter 44 are threaded 48, 49 so that the filters can be joined and subsequently disengaged to permit cleaning and/or replacement of one or the other, as necessary. In the embodiment of FIG. 2, the charcoal filter 44 is securely positioned in housing 47, which, in turn, is firmly attached through to a threaded exit fitting 46 in fluid communication with the spigot 35, which extends through the container wall and, in turn, is threadably 41 attached to mating threads 43 on a spigot 35, which is aligned with the filtration unit on the exterior side of the container wall 18. An O-ring 45 preserves an air-tight seal between the connection of the filtration unit housing 47 and the spigot 35. The spigot 35 is equipped with an on/off valve 36 to diminish the pressure effected by the hand-pump 50 thus encouraging the pressurized water to enter the two-stage filter unit and to exit the filtration device.

It is preferable for the pressurized water in the device 10 to initially enter the ceramic aspect 42 of the two-part filter. To increase the effectiveness and rate of filtration, the ceramic filter 42 is rounded or domed to increase the exposed surface area of the filter. The pores of the ceramic filter are between 0.2-0.3 microns. Pressurized water passing through the ceramic filter is cleansed of all suspended particles, most metals and almost all bacteria and viruses.

The second filtration element of the two-part filtration unit 42 is the activated charcoal filter 44 positioned between the ceramic filter 42 and the threaded fluid communication exit means 46 leading to the spigot 35. The charcoal filter 44 removes organic material, typically the source of objectionable odors, form the pressurized water and improves the taste or smell of the water markedly.

FIG. 3 is an alternative embodiment of the two-stage filtration unit 40. In this embodiment, the two-part filtration unit 40 is fused into a single unit, and when being serviced or replaced both the ceramic and the charcoal parts of the filtration unit are removed. In the embodiment of FIG. 3. the ceramic filter 42 envelopes the activated charcoal filter 44 and removal of both filters is facilitated by detaching the threaded 48 ceramic filter 42 from the threaded 51 filter housing 47. This embodiment primarily illustrates an easier way to service the filtration unit of the device.

The water filtration device 10 disclosed herein is designed and intended to be easily serviceable in the most remote and disadvantaged corners of the world. The device needs to be inexpensive to manufacture and maintain. All of the parts and/or elements of the device, except for the ceramic and activated carbon filters can be molded or fabricated from relatively inexpensive plastic materials that could be easy to transport and stock in the most primitive of environments or economies.

While the foregoing is a detailed and complete description of the preferred embodiment of the disclosed water filtration device, it should be apparent that numerous variations and modifications could be made to the disclosed device and utilized to implement the overall purpose of the device without deviating or departing from the spirit of the invention, which is fairly defined by the appended claims.

1. A water filtration device which comprises:
an air-tight, single-chambered container having inner and outer surfaces, a top side, a bottom side, a continuously curving lateral side extending between said top side and said bottom side, and wherein said top side is a removable lid attached to the contiguous upper perimeter of said curving side;
a lidded opening positioned within said lid serving as a port for the introduction of water to be filtered by said device and fitted with a strainer for the removal of any debris in said water;
a spigot attached to the outer surface of said lateral side;
a two-part filtration unit positioned on the inner surface of said lateral side, threadably attached to, and in fluid communication with, said spigot, said filtration unit having a ceramic filter and an activated charcoal filter; and
a hand-activated pump attached to said removable lid to pressurize water within said device, forcing said water through said filtration unit and into said spigot by which said filtered water can be removed from said device.

2. The water filtration device according to claim 1 wherein said ceramic filter has a pore size of between 0.2 and 0.3 microns.

3. The water filtration device according to claim 1 wherein said activated charcoal filter is positioned between said ceramic filter and said spigot.

4. The water filtration device according to claim 1 wherein said lid of said lidded opening engages with said opening in a friction fit.

5. The water filtration device according to claim 1 wherein said lid of said lidded opening engages with said opening in a threaded fit.

6. The water filtration device according to claim 1 wherein said two-part filtration unit is threadably attached to a filter housing.

7. The water filtration device according to claim 1 wherein said ceramic and activated charcoal filters are threadably attached.

8. The water filtration device according to claim 1 further including a handle.

9. A method of filtering untreated water employing a device according to claim 1 which comprises:
pouring water through said lidded opening serving as a port for the introduction of water to be filtered and straining for the removal of debris;
closing said lidded opening;
activating said hand-pump to pressurize said water in said air-tight container; and
opening said spigot to urge said pressurized water through said two-part filtration unit and into said spigot for removal from said device.
